(19) United States
(12) Patent Application Publication
(10) Pub. No.: US 2011/0269047 A1
(43) Pub. Date: Nov. 3, 2011

(54) METAL-SUPPORTED, SEGMENTED-IN-SERIES HIGH TEMPERATURE ELECTROCHEMICAL DEVICE

(75) Inventors: Michael C. Tucker, Berkeley, CA (US); Craig P. Jacobson, Moraga, CA (US); Steven J. Visco, Berkeley, CA (US)

(73) Assignee: THE REGENTS OF THE UNIVERSITY OF CALIFORNIA, Oakland, CA (US)

(21) Appl. No.: 13/056,206

(22) PCT Filed: Oct. 29, 2008
(86) PCT No.: PCT/US08/81531

§ 371 Date: May 12, 2011

Related U.S. Application Data
(60) Provisional application No. 61/096,177, filed on Sep. 11, 2008.

(51) Int. Cl. H01M 4/86; H01M 8/02; H01M 8/24; H01M 8/00

(52) U.S. Cl. 429/452; 429/535; 429/532; 429/517; 429/522

(57) ABSTRACT

A segmented-in-series high temperature solid-state electro-chemical device in which the cell segments are supported on a substrate comprising a porous metal layer for mechanical strength and a non-conducting porous layer for electrical insulation between cell segments is fabricated by co-sintering at least the metal substrate, insulating layer, an electrode and electrolyte. This allows for efficient manufacturing and the use of a thinner electrolyte (e.g., less than 40 microns thick) than in conventional designs, with a resulting performance improvement attributable at least in part to increased ionic conductivity. Alternative structures for the cell and interconnect repeat segments which are supported on a metallic substrate, as well as methods for producing said structures, specific compositions of the interconnect, and Al-containing compositions for the metallic substrate are described.

### CROSS-REFERENCE TO RELATED APPLICATION

This application claims priority to U.S. Provisional Patent Application No. 61/096,177, entitled “METAL-SUPPORTED, SEGMENTED-IN-SERIES HIGH TEMPERATURE ELECTROCHEMICAL DEVICE” (Attorney Docket No. LBNLP031P/WIB-2401), which was filed on Sep. 11, 2008 and which is hereby incorporated by reference in its entirety.

### STATEMENT OF GOVERNMENT SUPPORT

This invention was made with government support under Prime Contract DE-AC02-05CH11231 awarded by the United States Department of Energy to The Regents of the University of California for the management and operation of the Lawrence Berkeley National Laboratory. The government has certain rights in this invention.

### FIELD OF THE INVENTION

The present invention relates to high-temperature solid-state electrochemical devices, such as solid oxide fuel cells, and methods of making such high-temperature solid-state electrochemical devices having improved performance characteristics.

### BACKGROUND

High-temperature solid-state electrochemical devices are typically cells that include two porous electrodes, the anode and the cathode, and a dense solid electrolyte membrane disposed between the electrodes. In the case of a typical solid oxide fuel cell, for example, the anode is exposed to fuel and the cathode is exposed to an oxidant in separate closed systems to avoid any mixing of the fuel and oxidants. Solid oxide fuel cells normally operate at high temperatures, between about 650° C. and about 1000° C., to maximize the ionic conductivity of the electrolyte membrane. At appropriate temperatures, the oxygen ions easily migrate through the crystal lattice of the electrolyte.

Typical segmented-in-series device designs utilize thin anode/electrolyte/cathode unit cells supported on a porous ceramic tube or sheet. Many cells are disposed on a single support substrate and the cells are connected in series so as to build up voltage while maintaining relatively low current densities. The individual cell size is generally limited by the in-plane conduction of the electrodes. Individual cells are electrically connected and sealed by a dense conductive interconnect material. The surface of the support substrate that contacts the active cell components must be electrically insulating so as to prevent short-circuit between adjacent cells. Typical segmented-in-series designs are provided in U.S. Pat. No. 3,402,230, JP9092301, and US 2006/0153974A1, incorporated by reference herein for the purpose of describing basic segmented-in-series designs and fabrication.

It is desirable for solid oxide fuel cells and other solid state electrochemical devices to be supported on a metallic substrate because the metallic substrate can impart high strength, efficient current collection, low materials cost, and manufacturability to the devices. Metal-supported SOFCs are described in U.S. Pat. No. 6,605,316. A specific structure comprising segmented-in-series SOFCs supported on a metallic substrate is described in U.S. Pat. No. 3,525,646.

### SUMMARY OF THE INVENTION

The invention provides for a segmented-in-series high temperature solid-state electrochemical device in which the cell segments are supported on a substrate comprising a porous metal layer for mechanical strength and a non-conducting porous layer for electrical insulation between cell segments. The invention also provides for metallic seals and/or interconnects between cell segments. Such a device is more robust, and more easily manufactured at lower cost compared to existing segmented-in-series designs. The device is fabricated by co-sintering at least the metal substrate, insulating layer, an electrode and electrolyte. This allows for efficient manufacturing and the use of a thinner electrolyte (e.g., less than 40 microns thick) than in conventional designs, with a resulting performance improvement attributable to increased ionic conductivity.

The present invention extends the utility of metallic substrates to support segmented-in-series SOFCs with higher performance. The invention provides alternative structures for the cell and interconnect repeat segments which are supported on a metallic substrate, as well as methods for producing said structures, specific compositions of the interconnect, and Al containing compositions for the metallic substrate.

These and other aspects and features of the present invention are described below with reference to the figures.

### BRIEF DESCRIPTION OF THE DRAWINGS

FIG. 1 illustrates a cross-sectional view of a general design of a segmented-in-series solid-state electrochemical device (e.g., an SOFC stack) in accordance with the present invention.

FIGS. 2A-B illustrate cross-sectional views of alternative embodiments of segmented-in-series solid-state electrochemical devices in accordance with the present invention wherein the Interconnect seals against the Electrolyte and Electrode 1, but does not contact the Insulating Layer.

FIGS. 3A-D illustrate cross-sectional schematic views of various alternative embodiments of segmented-in-series solid-state electrochemical devices in accordance with the present invention integrating current collectors in various different ways.

FIGS. 4A-C depict alternative geometric embodiments of segmented-in-series solid-state electrochemical devices in accordance with the present invention.

FIG. 5 depicts a process flow showing operations in a method of making a segmented-in-series high temperature solid-state electrochemical device in accordance with the present invention.

### DETAILED DESCRIPTION OF SPECIFIC EMBODIMENTS

Reference will now be made in detail to specific embodiments of the invention. Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the scope of the appended claims. In the following description, numerous specific details are set forth in order to provide a thorough understanding of the present invention. The present invention may be practiced without some or all of these specific details. In other instances, well-known process operations have not been described in detail so as to not unnecessarily obscure the invention.

Introduction

A segmented-in-series high temperature solid-state electrochemical device in which the cell segments are supported on a substrate comprising a porous metal layer for mechanical strength and an electrically non-conducting porous layer for electrical insulation between cell segments (referred to as the ‘insulating layer”) is fabricated by co-sintering at least the metal substrate, insulating layer, an electrode and electrolyte. This allows for efficient manufacturing and the use of a thinner electrolyte (e.g., less than 40 microns thick) than in conventional designs, with a resulting performance improvement attributable at least in part to increased ionic conductivity.

The invention extends the utility of metallic substrates to support segmented-in-series electrochemical devices, solid oxide fuel cells (SOFCs) for example, with higher performance. The invention provides alternative structures for the cell and interconnect repeat segments which are supported on a metallic substrate, as well as methods for producing said structures, specific compositions of the interconnect, and Al-containing compositions for the metallic substrate.

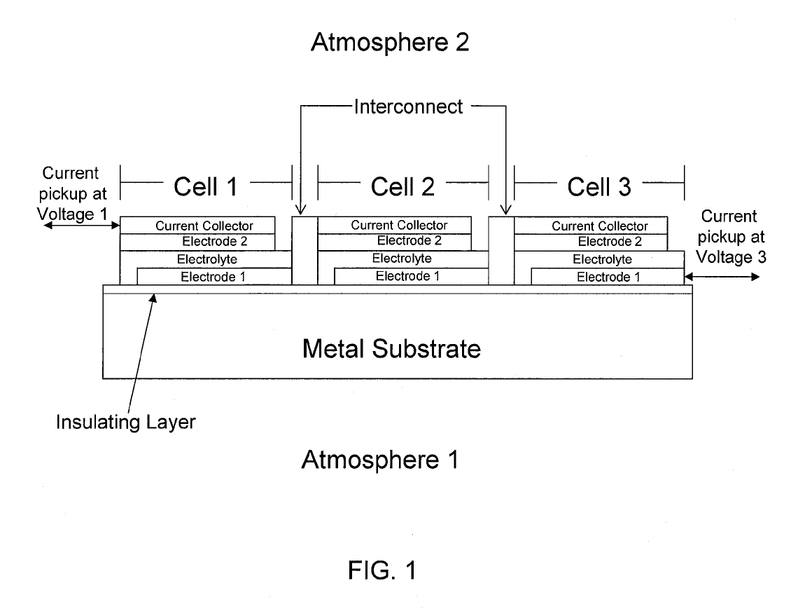

The invention provides for a segmented-in-series solid-state electrochemical device (e.g., an SOFC stack) that is supported on a substrate comprising a porous metallic layer. A general design in accordance with the present invention is illustrated in FIG. 1. Three cells are shown, but any number of cells greater than or equal to two may be arranged in this way. Individual cells comprise an Electrode 1, Electrolyte, Electrode 2, and Current Collector. Cells are sealed and electrically connected by an Interconnect structure. In order for the Electrode 1 units in adjacent cells to be electrically isolated from one another, a porous Insulating Layer is disposed between the Metal Substrate support and the thin active layers of the cells.

The Electrolyte is thinner than in conventional designs, a feature made possible by the co-sintering of at least the Metal Substrate, Insulating Layer, Electrode 1 and Electrolyte. The Electrolyte is less than 40 microns thick, and can be about 5-25 microns thick in specific embodiments, for example about 5, 10, 15, 20 or 25 microns thick. This is much thinner than in conventional designs which rely of other fabrication techniques, for example flame spraying of the electrolyte, with which formation of such a thin gas-tight electrolyte has not been achieved. The thinner electrolytes of the devices in accordance with this aspect of the invention provide a device with improved performance attributable at least in part to increased ionic conductivity of the Electrolyte, which, while thin, is gas-tight and robust.

Sealing between Atmospheres 1 and 2 is provided by the Electrolyte, Interconnect, and possibly an auxiliary sealing member that spans the Electrolyte and Interconnect.

Device Structure

The invention is primarily described herein with reference to SOFCs, however it will be understood by those skilled in the art that principles of the invention are applicable to solid-state electrochemical devices more generally, such as gas separators or oxygen generators by alteration of the composition and/or arrangement of elements and/or operation of devices.

The following common material abbreviations, used in the art, are sometimes used in the description that follows:

“YSZ” is (ZrO₂)ₓ(Y₂O₃)_{y} where (0.88≧X≧0.97) and (0.03≦y≦0.12). Specific materials include (ZrO₂)_{0.92}(Y₂O₃)_{0.08} or (ZrO₂)_{0.90}(Y₂O₃)_{0.10} that are available commercially.

“SSZ” is (ZrO₂)ₓ(Sc₂O₃)_{y} where (0.88≧X≧0.97) and (0.03≦y≦0.12). Specific materials include have y=0.09−0.11. Additional elements such as Ce and Y may be added to improve phase stability.

“LSM” is La₁₋ₓSrₓMn_{y}O_{3-δ} where (0.50≧X≧0.05) (0.95≦y≦1.15) (δ is defined as that value signifying a small deviation from perfect stoichiometry, as understood in the art). Specific materials include La_{0.85}Sr_{0.15}MnO_{3-δ}, La_{0.8}Sr_{0.2}MnO_{3-δ}, La_{0.65}Sr_{0.30}MnO_{3-δ}, and La_{0.45}Sr_{0.55}MnO_{3-δ}.

“LNF” is LaNiₓFe₁₋ₓ O_{3-δ} where (0<X<1) (δ is defined as that value signifying a small deviation from perfect stoichiometry, as understood in the art). Specific materials include LaNi O_{3-δ}, LaNi_{0.4}Fe_{0.6} O_{3-δ}, LaNi_{0.6}Fe_{0.4} O_{3-δ, LaNi}_{0.2}Fe_{0.8} O_{3-δ, and LaNi}_{0.8}Fe_{0.2} O_{3-δ}.

“SYTO” is Sr₁₋ₓY_{z}TiO_{3-δ} where (0.5≧X≧0) (0≦Z≦0.5) (δ is defined as that value signifying a small deviation from perfect stoichiometry). In some alternate materials having the same stoichiometry, Y may be replaced by La.

“CGO” is (CeO₂)ₓ(Gd₂O₃)_{y} where (0.50≧X≧0.97) and (0.03≦y≦0.50). The preferred material is (CeO₂)_{0.90}(Gd₂O₃)_{0.05} or (CeO₂)_{0.80}(Gd₂O₃)_{0.10}. Gd may be replaced in total or in part by Y, La, Sm, and Ca.

A quantification or characterization of a particular feature of the present invention may sometimes be qualified by the terms “substantially” or “about.” In such instances, the term should be understood to mean an approximation as would be generally understood by those of skill in the art in the context in which the term is used, so as to encompass any insubstantial difference from the described or claimed value or feature.

Various materials may be used for the electrodes and electrolyte. Referring again to FIG. 1, either of Electrodes 1 or 2 may be the anode or the cathode. Particular embodiments comprise the following features: (a) Electrode 1 is a porous anode, comprising a catalyst, which can be Ni, and an oxide conductor such as YSZ, SSZ, or CGO; (b) the Electrolyte is dense and may be an oxide ion conductor such as YSZ, SSZ, or CGO, a proton conductor, or a mixed conductor; (c) Electrode 2 is a porous cathode, comprising an oxide catalyst such as LSM, LSCF (La—Sr—Cr—Fe oxide), or LNF (La—Ni—Fe oxide) and an oxide conductor such as YSZ, SSZ, or CGO; (d) the Insulating Layer comprises a porous ceramic such as YSZ, SSZ, CGO, MgO, or Al₂O₃; and (e) the Metal Substrate and Current Collector comprise porous metal or cermet wherein the porous metal is selected from the group consisting of FeCr, NiCr, Ni, Ag, Cu, Al, Ti, Mo and alloys and mixtures thereof. Electrode 2 may comprise a network of oxide conductor, infiltrated with the oxide catalyst, as described in commonly assigned co-pending International Patent Application No. WO 2006/116153, the disclosure of which in this regard is incorporated herein by reference. Electrode 1 may also comprise infiltrated material, such as infiltrated Ni to increase electrochemically active surface area, infiltrated CeO₂ to increase sulfur tolerance and performance, etc.

Electrode 1 may receive infiltrated material through the Insulating Layer. In this case, an electrical short-circuit between adjacent cells becomes a concern because the infiltrated material may impart electrical conductivity to the Insulating Layer. Short-circuit can be avoided by (a) infiltrating a material that is not conductive; (b) infiltrating a small amount of a conductive material such that the material does not form a percolating network for electronic conduction; or (c) masking the areas between adjacent cells before infiltrating so as to block the infiltrated material from entering the masked areas.

The Electrolyte is less than 40 microns thick, and can be about 5-25 microns thick in specific embodiments, for example about 5, 10, 15, 20 or 25 microns thick. This is much thinner than in conventional designs which rely of other fabrication techniques, for example flame spraying of the electrolyte, with which formation of such a thin gas-tight (dense) electrolyte has not been achieved. The thinner electrolytes of the devices in accordance with this aspect of the invention provide a device with improved performance attributable at least in part to increased ionic conductivity of the Electrolyte, which, while thin, is gas-tight and robust.

The metal used to fabricate the Metal Substrate can be selected from the group of Al₂O₃-forming, SiO₂-forming, and Cr-forming alloys, including ferritic stainless steels. Unlike many other metal-supported SOFC designs, the metal support of electrochemical devices in accordance with this invention does not participate in current collection and thus does not need to be highly electronically conductive. Therefore, alloys that form an insulating scale such as Al₂O₃ or SiO₂ can be employed, providing greatly reduced oxidation kinetics as a benefit over alloys that form only a Cr₂O₃ scale, such as are typically used in conventional SOFC designs.

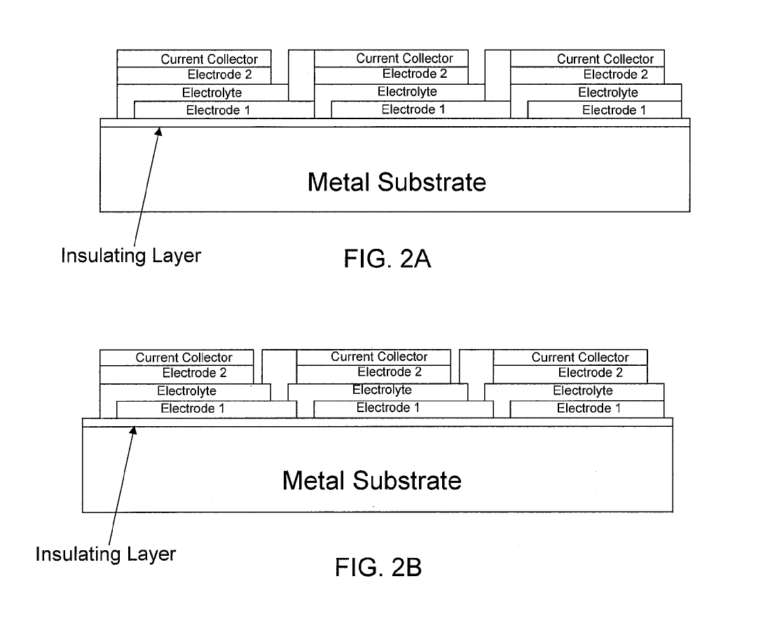

The invention is further described with reference to several electrochemical device structure embodiments shown in FIGS. 1, 2A-B and 3A-D. In these designs, the Metal Substrate, Insulating Layer, Electrodes, and Current Collector are all porous. Therefore, sealing between Atmospheres 1 and 2 (on the Substrate and active device side of the device, as shown in FIG. 1) is provided by the Electrolyte, Interconnect, and possibly an auxiliary sealing member that spans the Electrolyte and Interconnect.

The seal is gas-tight. Various materials can be used as the seal, including electrolyte (YSZ, SSZ, CGO, etc), glass, ceramic, braze alloys, and metals particularly those selected from the group consisting of FeCr, NiCr, Ni, Ag, Cu, and alloys and mixtures thereof. It is not necessary that a single material provide the sealing function; it can be desirable to use combinations of these listed materials to fabricate the seal. Some specific suitable combinations include: braze and electrolyte; metal and electrolyte; and, braze, metal, and electrolyte.

The interconnect material is electronically conductive. Various materials can be used as the Interconnect, including conductive ceramics (i.e. LaCrO₃ and related compositions), braze alloys, ceramic metal composites (cermets), and metals, particularly those selected from the group consisting of FeCr, NiCr, Ni, Ag, Cu, and alloys and mixtures thereof. Preferred materials or combinations of materials will provide both the sealing and interconnection function. One such preferred material is a Ag-based braze comprising a reactive element such as Ti that promotes wetting and sealing of the braze on the electrolyte and/or insulating layer surface. A modification of such a braze material to provide a better CTE match between the braze and electrolyte is described in commonly assigned co-pending International Patent Application No. WO 2006/086037, the disclosure of which in this regard is incorporated herein by reference. Other possible sealing interconnects include conductive ceramics, metallized glass, or metallized ceramic.

In a specific embodiment, as depicted in FIG. 1, the Interconnect seals against the Electrolyte, Insulating Layer, and Electrode 1. This is in contrast to prior designs, such as that depicted in U.S. Pat. No. 3,525,646, wherein the Interconnect does not contact or seal against the insulating layer. The preferred materials for the Interconnect comprise braze alloys or ferritic stainless steels.

FIGS. 2A and 2B show alternative embodiments of electrochemical devices in accordance with the present invention wherein the Interconnect seals against the Electrolyte and Electrode 1, but does not contact the Insulating Layer. In this case, because the Interconnect and Insulating Layer do not contact, compatibility between the materials comprising these two layers is not necessary. For instance, the Interconnect material need wet the Insulating Layer material thereby creating a seal, as in the arrangement of FIG. 1. Furthermore the Interconnect and Insulating Layer may be made of materials that would react if they were in contact. A further advantage is that the placement of the Interconnect along the length of Electrode 1 is flexible for the embodiments of FIGS. 2A-B. In the embodiment of FIG. 1, registration of the Electrode 1 and Electrolyte layers is maintained during deposition so as to preserve access to the Insulating Layer surface for application of the Interconnect in a later step. In the embodiments of FIGS. 2A-B, variability in the placement of the gap between adjacent Electrolyte layers over Electrode 1 is acceptable, allowing for less stringent manufacturing requirements.

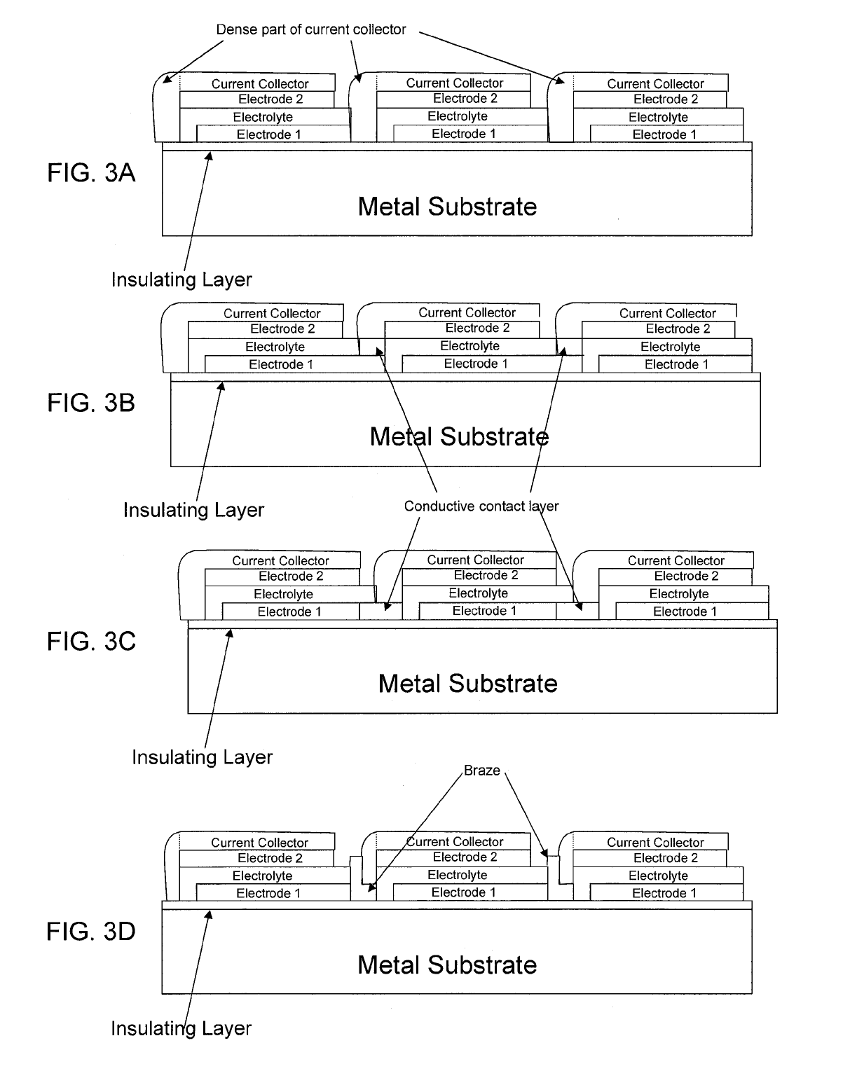

If the conductivity of Electrode 2 is not particularly high, efficient current collection can be provided by a separate Current Collector. The Current Collector must be conductive and comprise a porous part to allow gas flow to Electrode 2, but does not need to support electrochemical reaction. A preferred material for the current collector is ferritic stainless steel. The Current Collector may comprise a porous part near Electrode 2, and a dense part extending away from Electrode 2 as illustrated in FIG. 3A. The dense part of the Current Collector can participate in sealing and interconnection by contacting the Electrolyte, Insulating Layer, and/or Electrode 1.

One preferred method of fabricating such a current collector is to sinter it onto Electrode 2. The chemical composition, green density, and particle size of the current collector can vary such that part of it becomes dense during sintering, and part remains porous. In the case of a tubular SOFC, the current collector can be shrink-sintered into place according to techniques described in commonly assigned co-pending International Patent Application No. WO 2008/016345, the disclosure of which in this regard is incorporated herein by reference. The current collector may further be coated with a material that aids bonding and sealing, as described in commonly assigned co-pending International Patent Application No. PCT/US08/66737, the disclosure of which in this regard is incorporated herein by reference. A preferred material for this coating is the material of the electrolyte. Sealing at the edge of the current collector may optionally be enhanced by brazing the current collector to adjacent layers, as shown in FIG. 3D.

It is possible that the Current Collector and Electrode 1 materials are incompatible under the fabrication or operating conditions. For instance the materials may react during sintering or interdiffuse over long operating lifetimes. In this case it is desirable to dispose an electrically conductive contact layer between the current collector and Electrode 1, as illustrated in FIGS. 3B and 3C. Preferred materials for this conductive contact layer include conductive ceramics such as doped LaTiO₃ and SrTiO₃, and metals, particularly those selected from the group consisting of FeCr, NiCr, Ni, Ag, Cu, and alloys and mixtures thereof.

Electrode 1 may also contact a Current Collector, for instance a high-conductivity layer disposed between the insulating layer and Electrode 1, for example as illustrated in FIG. 3A. Preferred materials for this Current Collector include metals particularly those selected from the group consisting of FeCr, NiCr, Ni, Ag, Cu, and alloys and mixtures thereof.

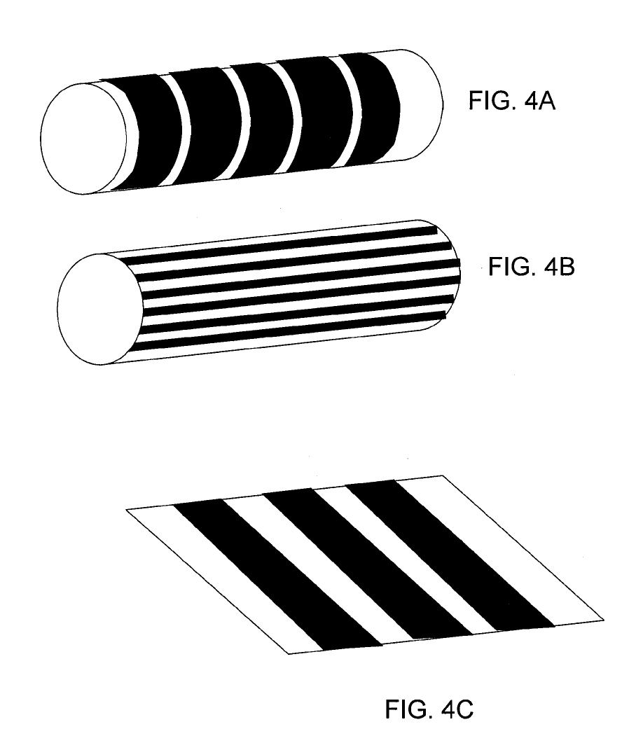

Individual cell segments may be placed in series connection in a variety of geometries. Some possibilities including axial tubular (4A), longitudinal tubular (4B), and planar stripes (4C) are illustrated in FIGS. 4A-C, wherein cells are represented by dark areas and interconnections are represented by light areas. Cells may be supported on various support geometries, including tubular, planar, and flattened tubular.

Device Fabrication

Devices in accordance with this invention are manufactured by a method that involves cosintering of multiple layers. Cosintering can provide good mechanical interlocking and bonding between layers, and shrinkage of the substrate during sintering aids electrolyte densification. According to the present invention a segmented-in-series high temperature solid-state electrochemical device in which the cell segments are supported on a substrate comprising a porous metal layer for mechanical strength and a non-conducting porous layer for electrical insulation between cell segments is fabricated by co-sintering at least the metal substrate, insulating layer, an electrode and electrolyte. It is possible to cosinter all of the layers shown in FIG. 1 together in a single step.

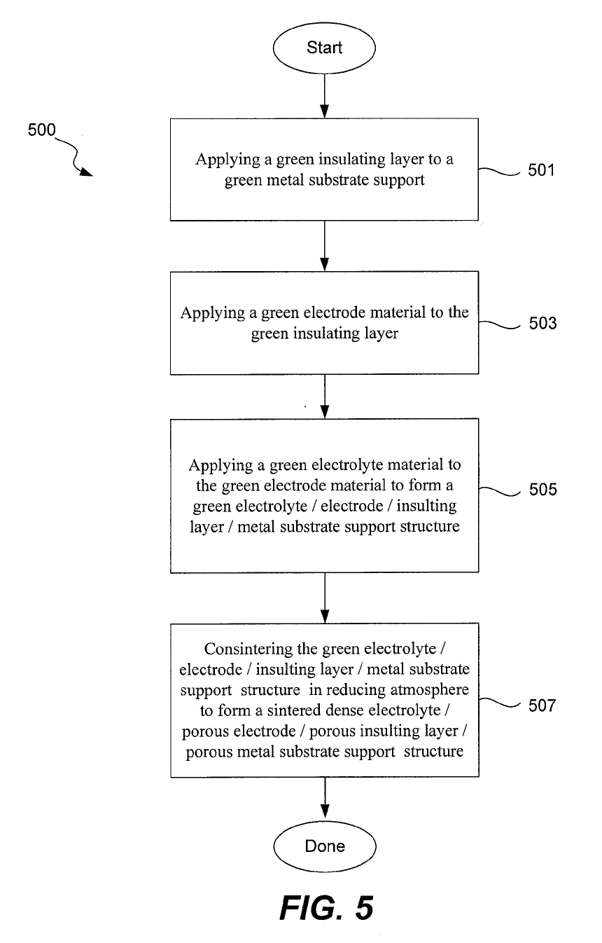

A process flow showing operations in a method of making a segmented-in-series high temperature solid-state electrochemical device in accordance with the present invention is shown in FIG. 5. The process 500 begins at 501 with a green insulating layer being applied to a green metal substrate support. The characterization of a material as green is not intended to exclude the possibility that the material could be bisque fired where appropriate, such as, for example, where an intermediate substrate in a fabrication process is bisque fired prior to application of the next green material and/or prior to sintering, as described herein. Then a plurality of cell segments is formed on the support and insulating layer. At 503, a green electrode material is applied to the green insulating layer. At 505, a green electrolyte material is applied to the green electrode material to form a green electrolyte/electrode/insulting layer/metal substrate support structure. At 507, the green electrolyte/electrode/insulting layer/metal substrate support structure is cosintered in a non-oxidizing atmosphere to form a sintered dense electrolyte/porous electrode/porous insulting layer/porous metal substrate support structure.

To prevent oxidation of the Metal Substrate, the sintering is carried out in a non-oxidizing atmosphere. Generally, the non-oxidizing atmosphere is a reducing atmosphere (e.g., about 4% H₂/Ar or similar at about 1000-1400° C.) and this also cleans the metal surface. However, an inert or vacuum environment may also be used in some instances, particularly when the metal is clean. Typical cathode materials, including LSM and LSCF decompose in reducing atmosphere. Therefore it is desirable to prepare the cathode by infiltration of the catalyst after sintering. For instance, the cathode may comprise a YSZ or SSZ network prepared during the sintering step and a coating of LSM on the walls of this network prepared as described in commonly assigned co-pending International Patent Application No. WO 2006/116153, the disclosure of which in this regard is incorporated herein by reference. The anode may also comprise infiltrated particles. For instance, an anode of Ni—YSZ may be infiltrated with CeO₂ particles to enhance sulfur tolerance and performance, or an anode network of Cu—YSZ or (Sr, Y)TiO3—YSZ may be infiltrated with Ru, Ni, and/or CeO₂particles to enhance catalytic activity.

In specific embodiments, some but not all of the layers shown in FIG. 1 are cosintered. For instance, in one preferred embodiment, the Metal Substrate, Insulating Layer, Electrode 1 and Electrolyte are cosintered in a single step, preferably in reducing atmosphere at 1000-1400° C. This allows the opportunity for quality assurance of the electrolyte layer before adding Electrode 2 and the Current Collector. The current collector, with or without a dense Interconnect section as shown in FIGS. 3A-D, may be applied according to techniques described in commonly assigned co-pending International Patent Application No. WO 2008/016345, the disclosure of which in this regard is incorporated herein by reference.

The various layers making up the substrate and cell layers may be prepared by any of a variety of techniques known to those of skill in the art and applicable for use in accordance with this invention given the disclosure provided herein. The Metal Substrate may be pressed, tape cast, centrifugally cast, extruded, injection molded, etc. The Insulating Layer, Electrodes, Electrolyte, Current Collector and Interconnect may be applied by co-extrusion, lamination, co-casting, aerosol spray, screen printing, decal transfer, dip coating, brush painting, etc. In the case of tubular geometry, some or all of the layers may be prefabricated as rings or sleeves which are then stacked up or slipped over the substrate before sintering. Any shrinkage in the rings or sleeves during sintering will cause radial compression and joining as described in commonly assigned co-pending International Patent Application No. WO 2008/016345, the disclosure of which in this regard is incorporated herein by reference. Preparation of the various layers may be as described in commonly assigned co-pending International Patent Application No. PCT/US08/60362, the disclosure of which in this regard is incorporated herein by reference.

### EXAMPLE

The following example is provided to better illustrate features of particular embodiments of the invention, and in no way limits the scope or spirit of the invention.

### Example 1

### Method of Manufacturing a Tubular SOFC

A high-temperature solid-state tubular SOFC may be fabricated as follows in accordance with the present invention:

1. Prepare ferritic stainless steel porous metal substrate support tube

2. Apply green insulating layer of porous YSZ ceramic

3. Apply green porous Ni—YSZ Electrode 1 (anode) material

4. Bisque fire in reducing atmosphere between 800-1200° C.

5. Apply green YSZ electrolyte

6. Cosinter in reducing atmosphere between 1000-1400° C.

7. Apply green porous YSZ Electrode 2 (cathode) material

8. Slip prefabricated current collector sleeves into place around tube

9. Cosinter in reducing atmosphere between 1000-1400° C.

10. Apply braze alloy as interconnect

11. Braze in reducing, inert or vacuum atmosphere between 800-1200° C.

12. Infiltrate LSM into Electrode 2

13. Mount device to electrical and gas flow connections and operate

### CONCLUSION

Although the foregoing invention has been described in some detail for purposes of clarity of understanding, it will be apparent that certain changes and modifications may be practiced within the scope of the appended claims. It should be noted that there are many alternative ways of implementing both the process and compositions of the present invention. Accordingly, the present embodiments are to be considered as illustrative and not restrictive, and the invention is not to be limited to the details given herein.

What is claimed:

1. A method of fabricating a segmented-in-series high temperature solid-state electrochemical device, comprising:
applying a green insulating layer to a green metal substrate support;
forming a plurality of cell segments on the support and insulating layer, the formation of each cell segment comprising,
applying a green electrode material to the green insulating layer;
applying a green electrolyte material to the green electrode material to form a green electrolyte/electrode/insulting layer/metal substrate support structure; and
cosintering the green electrolyte/electrode/insulting layer/metal substrate support structure in a non-oxidizing atmosphere to form a sintered dense electrolyte/porous electrode/porous insulting layer/porous metal substrate support structure.

2. The method of claim 1, wherein the cosintering is conducted in a reducing atmosphere at a temperature of about 1000-1400° C.

3. The method of claim 1, further comprising bisque firing the electrode/insulting layer/metal substrate support structure in non-oxidizing atmosphere prior to application of the green electrolyte material in a reducing atmosphere.

4. The method of claim 3, wherein the bisque firing is conducted at a temperature of about 800-1200° C.

5. The method of claim 1, further comprising applying a second green electrode material to the electrolyte of the sintered structure.

6. The method of claim 5, further comprising applying a green current collector material to the second green electrode material.

7. The method of claim 6, further comprising cosintering the green current collector material to the second green electrode material in reducing atmosphere at a temperature of about 1000-1400° C. to form the electrochemical device structure.

8. The method of claim 1, further comprising electrically interconnecting and sealing the plurality of cell segments to each other.

9. The method of claim 7, further comprising electrically interconnecting and sealing the plurality of segments to each other with metallic seals and/or interconnects between cell segments.

10. The method of claim 9, wherein the electrically interconnecting and sealing comprises applying a braze alloy or ferritic stainless steel sealing as interconnect.

11. The method of claim 10, wherein the electrically interconnecting and sealing comprises a braze applied in a reducing, inert, or vacuum atmosphere between 800-1200° C.

12. The method of claim 11, further comprising infiltrating a catalyst into the second electrode.

13. The method of claim 12, further comprising mounting the device to electrical and gas flow connections and operating the device.

14. The method of claim 9, wherein the device is a SOFC.

15. The method of claim 14, wherein:
the porous metal substrate support material is ferritic stainless steel,
the insulating layer material is selected from the group consisting of Al₂O₃, MgO, TiO₂, SSZ, YSZ, CGO, Ca-stabilized zirconia, Mg-stabilized zirconia, and mixtures thereof,
the electrode comprises a material is selected from the group consisting of YSZ, SSZ, LSM, Ni, LNF, LSCF, CGO, and mixtures thereof,
the electrolyte material is selected from the group consisting of YSZ and SSZ,
the second electrode comprises a material is selected from the group consisting of YSZ, SSZ, LSM, Ni, LNF, LSCF, CGO, and mixtures thereof,
the current collector material is selected from the group consisting of Ag, Cu, Ni, Fe, Cr, ferritic stainless steel, and mixtures and alloys thereof.

16. The method of claim 15, wherein the porous metal substrate support material is ferritic stainless steel, the insulating layer material is YSZ, the electrode material comprises YSZ, the electrolyte material is YSZ, the second electrode material comprises YSZ, and the current collector material is ferritic stainless steel.

17. The method of claim 16, wherein the porous metal substrate support material comprises Al.

18. The method of claim 17, wherein the porous metal substrate support material comprises Fe, Cr, Al, and Y.

19. The method of claim 1, further comprising, prior to the cosintering:
applying a second green electrode material to the green electrolyte material; and
applying a green current collector material to the second green electrode material.

20. The method of claim 1, wherein the electrolyte material is less than 40 microns thick.

21. The method of claim 1, wherein the electrolyte material is between about 5 and 25 microns thick.

22. The method of claim 1, wherein the device is tubular.

23. The method of claim 1, wherein the device is planar.

24. A segmented-in-series high temperature solid-state electrochemical device, comprising:
a cosintered structure, comprising a plurality of cell segments on a support comprising,
a porous metal substrate support;
a porous insulating layer on the porous metal substrate support;
each cell segment comprising,
a porous first electrode on the porous insulating layer,
a dense electrolyte on the porous electrode, and
wherein the electrolyte is less than 40 microns thick.

25. The device of claim 24, further comprising for each cell segment a second electrode on the electrolyte and a current collector on the second electrode.

26. The device of claim 25, wherein the device is a SOFC.

27. The device of claim 26, wherein:
the porous metal substrate support material is ferritic stainless steel,
the insulating layer material is selected from the group consisting of Al₂O₃, MgO, TiO₂, SSZ, YSZ, CGO, Ca-stabilized zirconia, Mg-stabilized zirconia, or mixtures thereof,
the electrode comprises a material is selected from the group consisting of YSZ, SSZ, LSM, Ni, LNF, LSCF, CGO, and mixtures thereof,
the electrolyte material is selected from the group consisting of YSZ and SSZ,
the second electrode comprises a material is selected from the group consisting of YSZ, SSZ, LSM, Ni, LNF, LSCF, CGO, and mixtures thereof,
the current collector material is selected from the group consisting of Ag, Cu, Ni, Fe, Cr, ferritic stainless steel, and mixtures and alloys thereof.

28. The device of claim 27, the porous metal substrate support material is ferritic stainless steel, the insulating layer material is YSZ, the electrode material comprises YSZ, the electrolyte material is YSZ, the second electrode material comprises YSZ, and the current collector material is ferritic stainless steel.

29. The device of claim 28, wherein the porous metal substrate support material comprises Al.

30. The device of claim 29, wherein the porous metal substrate support material comprises Fe, Cr, Al, and Y.

31. The device of claim 25, further comprising conductive metallic interconnects between cell segments electrically interconnecting and sealing the plurality of segments from each other.

32. The device of claim 31, wherein the interconnects are a braze alloy or ferritic stainless steel.

33. The device of claim 32, wherein the interconnects are in contact with the insulator layer.

34. The device of claim 24, wherein the device is tubular.

35. The device of claim 24, wherein the device is planar.
